(19) United States
(12) Patent Application Publication
(10) Pub. No.: US 2026/0180905 A1
(43) Pub. Date: Jun. 25, 2026

(54) QUEUEING AND FLOW CONTROL MECHANISMS FOR EFFICIENT RESOURCE SHARING IN CROSSBARS AND DSPS

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/428,068

(22) Filed: Dec. 19, 2025

Related U.S. Application Data
(60) Provisional application No. 63/737,544, filed on Dec. 20, 2024.

(51) Int. Cl. H04L 47/12; H04L 47/30; H04L 47/62

(52) U.S. Cl. CPC H04L 47/12; H04L 47/30; H04L 47/623

(57) ABSTRACT

Technology for a device includes a plurality of digital signal processors (DSPs) and a plurality of analog crossbars in communication with the DSPs. The DSPs dynamically adjust queues to optimize data flow based on traffic conditions, latency, and resource availability. Queues may include input queues, output queues, virtual output queues, or hybrid configurations, supporting techniques such as priority scheduling and time-division multiplexing (TDM). The DSPs facilitate flow control through granular backpressure signaling, managing congestion between DSPs and endpoints. Synchronization of queues during crossbar reconfiguration ensures seamless traffic flow and prevents data loss. Advanced mechanisms, such as dynamic queue depth adjustment and adaptive prioritization, enable efficient resource sharing while maintaining high throughput. The device leverages these features to provide scalable, energy-efficient networking solutions for complex environments, such as data centers and telecommunication system

### RELATED APPLICATION

This application claims the benefit of U.S. Provisional Application No. 63/737,544, filed Dec. 20, 2024, the disclosure of which is incorporated herein by reference in its entirety.

The examples discussed in the present disclosure are related to PMD and crossbar synchronization techniques for fast reconfiguration and data integrity.

### BACKGROUND

Unless otherwise indicated herein, the materials described herein are not prior art to the claims in the present application and are not admitted to be prior art by inclusion in this section.

Datacenters and artificial intelligence (AI) clusters may use Ethernet switches that are packet switched. Using a packet switched Ethernet switch results in delivery that is not reliable, is variable, and has high latency. Fabric switches provide another possibility in datacenters and AI clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A system and device includes digital signal processors (DSPs) in communication with analog crossbars, where the DSPs dynamically adjust queues to manage data flow efficiently. These queues may include input, output, virtual output, or hybrid configurations and can be adjusted in response to factors such as traffic conditions, latency, and resource availability. The queue adjustment ensures seamless traffic management and optimal resource utilization.

In some embodiments, a method involves connecting DSPs to analog crossbars and dynamically adjusting queues within the DSPs. The adjustment may include modifying queue depth, prioritization, or structure to maintain high throughput and reduce latency under varying network conditions. The method supports synchronization of queues during crossbar reconfiguration to minimize traffic delays and prevent data loss. In some embodiments, another method includes connecting DSPs to analog crossbars and facilitating flow control at the DSPs. This flow control may involve backpressure signaling to regulate traffic between DSPs and endpoints, ensuring efficient resource sharing and congestion mitigation.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device including digital signal processors and analog crossbars.

FIG. 2 illustrates an example device for flow control.

FIG. 3 illustrates an example timing diagram for flow control.

FIG. 4 illustrates an example process flow for queues.

FIG. 5 illustrates an example process flow for flow control.

FIG. 6 illustrates an example communication system operable for queueing and/or flow control.

FIG. 7 illustrates a diagrammatic representation of a machine in the example form of a computing device within which a set of instructions, for causing the machine to perform any one or more of the methods discussed herein, may be executed.

FIG. 8A illustrates an example block diagram of a data center.

FIG. 8B illustrates an example switch device.

FIG. 8C illustrates an example switch device.

FIG. 8D illustrates an example switch device.

### DESCRIPTION

The systems and methods of the examples described below pertains to the field of high-speed network switches and so-called physical media dependent (PMD) devices with crossbar-based architectures. Modern networks often experience fluctuating traffic patterns and congestion, requiring dynamic and efficient allocation of crossbar resources. Traditional static or fixed-path routing techniques lack the flexibility to respond to real-time network demands, often leading to inefficient bandwidth utilization and increased latency.

Efficient management of traffic flow and resource sharing in networking systems is advantageous for maintaining high-speed data transmission and preventing bottlenecks. Traditionally, digital signal processors (DSPs) have operated as pass-through components, transferring data from inputs to outputs at the source data rate without intermediate traffic management. This approach limited their ability to handle modern networking demands, such as dynamic traffic prioritization, resource allocation, and congestion control. To address these challenges, the described embodiments below introduce queueing and flow control mechanisms implemented directly within DSPs and crossbars, enabling advanced traffic management, efficient resource utilization, and seamless communication with endpoints. For example queuing and flow control mechanisms may be used to manage bandwidth, control traffic flow, and prevent data bottlenecks in crossbar systems.

The device may include a plurality of DSPs in communication with analog crossbars. In some embodiments, one or more individual DSPs may be equipped with input and output queues, including virtual output queues (VOQs), to facilitate dynamic management of incoming and outgoing traffic. The addition of MAC or IP addressing capabilities enables DSPs to process and prioritize packetized data, significantly enhancing their ability to manage complex traffic patterns. Examples of the described herein will be explained with reference to the accompanying drawings.

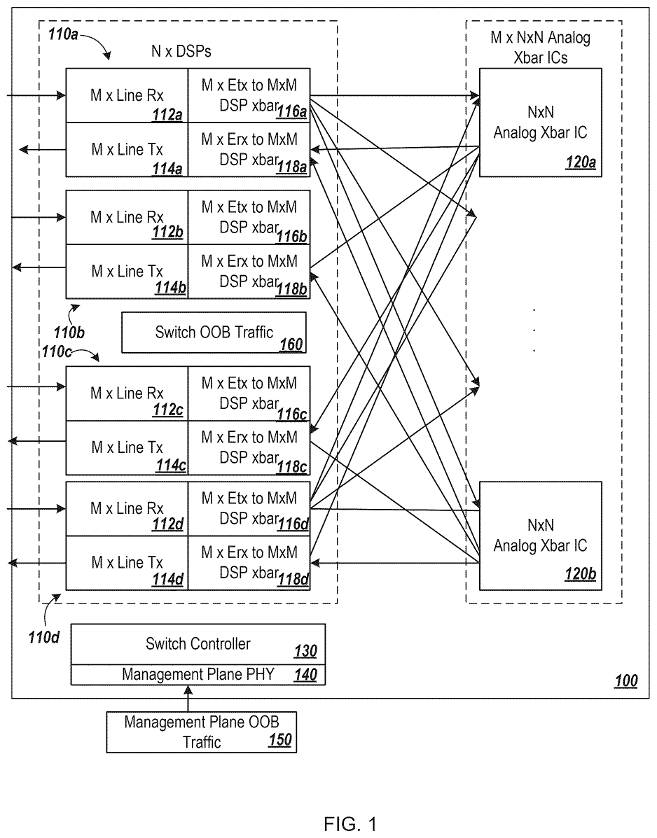

As illustrated in FIG. 1, an analog electrical circuit switch (AECS) 100 may include one or more digital signal processors (DSPs) 110a, 110b, 110c, 110d. The AECS 100 may include a switch controller 130. The AECS 100 may include one or more analog crossbars (“xbar”) integrated circuits (IC) (e.g., analog crossbars 120a, 120b).

DSPs 110a, 110b, 110c, 110d may be devices integrating layer 1 (L1) for line and switch side inputs and outputs. A DSP 110a may include an M×Line Rx 112a, an M×Line Tx 114a, an M×ETx to M×M DSP xbar 116a, and an M×ERx to M×M DSP xbar 118a. A DSP 110b may include an M×Line Rx 112b, an M×Line Tx 114b, an M×ETx to M×M DSP xbar 116b, and an M×ERx to M×M DSP xbar 118b. A DSP 110c may include an M×Line Rx 112c, an M×Line Tx 114c, an M×ETx to M×M DSP xbar 116c, and an M×ERx to M×M DSP xbar 118c. A DSP 110d may include an M×Line Rx 112d, an M×Line Tx 114d, an M×ETx to M×M DSP xbar 116d, and an M×ERx to M×M DSP xbar 118d. A DSP xbar may be a digital crossbar integrated in the DSP.

A PMD device may include a DSP 110a, 110b, 110c, 110d. The PMD may be an electrical-optical module or an electrical-electrical module.

A client may be a system communicating line-side in-band traffic to the AECS 100. For example, a server may be a system communicating line-side in-band traffic to the AECS 100.

Line-side in-band (IB) bandwidth may be line traffic communicated to or from a client. IB switch traffic may be IB traffic directed into or out of or within the AECS 100.

The switch controller (SC) 130 may manage and control AECS 100 devices. In one example, the switch controller 130 may be a microcontroller unit (MCU). Alternatively or in addition, the switch controller 130 may be a DSP 110a, 110b, 110c, 110d.

Switch out-of-band (OOB) traffic may be traffic among the SC 130, DSP 110a, 110b, 110c, 110d, analog crossbars 120a, 120b carried on a different network and physical layer than IB traffic. Switch OOB traffic may be carried on analog crossbars 120a, 120b with redundancy.

An “Xbar IC” may be an analog Xbar IC which may be a chip implementing an analog crossbar with input and output lanes.

Management plane OOB traffic may be traffic from outside the AECS 100 via management plane physical layer (PHY) to configure and manage the AECS 100.

The device may include a plurality of DSPs in communication with analog crossbars. For example, the device may include DSPs 110a, 110b, 110c, 110d and analog crossbars 120a, 120b in communication with DSPs 110a, 110b, 110c, 110d. DSPs 110a, 110b, 110c, 110d may adjust a queue at DSPs 110a, 110b, 110c, 110d. In one example, the queue may be adjusted by adjusting one or more of a queue depth or a queue prioritization. The queue depth may be adjusted in response to traffic demands, latency targets, and/or resource availability. The queue prioritization may be adjusted in response to traffic demand, latency targets, and/or resource availability. Queues may be implemented at the input and/or output of the device.

In some embodiments, each, or at least some individual DSPs are equipped with input and output queues, including virtual output queues (VOQs), to facilitate dynamic management of incoming and outgoing traffic. The addition of MAC or IP addressing capabilities enables DSPs to process and prioritize packetized data, significantly enhancing their ability to manage complex traffic patterns.

As shown in FIG. 1, an AECS switch 100 integrates DSPs 110a-110d, crossbars 120a-120c, and a switch controller 130. Traffic from endpoints, such as servers or storage systems, enters the DSPs through line-side interfaces 112a-112d. Within the DSPs, queues dynamically manage data flow based on traffic conditions, latency, and resource availability. The switch controller 130 coordinates flow control signals, ensuring efficient data transmission across the system.

The queue may be one or more of an input queue, an output queue, a virtual output queue, a hybrid queue (e.g., of an input queue, and output queue, or a virtual output queue), or the like. The queue may be virtual (e.g., at a client) or physically implemented (e.g., at DSPs 110a, 110b, 110c, 110d). Input or output queuing, when implemented at DSPs 110a, 110b, 110c, 110d, may support time-division multiplexing (TDM) of the crossbar.

DSPs 110a, 110b, 110c, 110d may synchronize the queue in which the queue is one or more of an input queue, an output queue, or the like. Synchronizing input and/or output queues during crossbar reconfiguration may minimize the impact of traffic delays and/or congestion. Thus, input queuing may be synchronized with crossbar reconfiguration and output queueing. DSPs 110a, 110b, 110c, 110d may synchronize the queue during crossbar reconfiguration.

DSPs 110a, 110b, 110c, 110d may facilitate network resource sharing by adjusting the queue. TDM techniques may allow multiple DSPs to share connection bandwidth using cyclical time-division allocations which may enhance efficiency. DSPs 110a, 110b, 110c, 110d (collectively “DSPs”) may include queuing specifically used for the sharing of a medium or resource e.g., using TDM.

In some embodiments, DSPs incorporate hybrid queueing mechanisms, combining input/output queues and VOQs. Input queues manage data arriving from endpoints, buffering traffic to prevent overload during periods of high demand. Output queues prioritize data transmission to crossbars based on destination and latency, while VOQs allow the DSP to maintain separate queues for each potential output port.

For example, DSPs use VOQs to allocate bandwidth for high-priority traffic streams, such as real-time video data, while queuing lower-priority traffic separately. This approach minimizes contention for shared resources and ensures that traffic is transmitted with minimal delay.

Dynamic queue depth adjustment enables the DSP to adapt to varying traffic conditions. During peak traffic periods, queue depth increases to accommodate higher data volumes, while in low-traffic scenarios, depth is reduced to conserve memory resources. Priority levels within queues are also dynamically reassigned based on real-time traffic metrics, such as bandwidth utilization and latency.

Flow Control in Shared Resources—flow control mechanisms within DSPs and crossbars prevent congestion by regulating the flow of data across shared resources. In some embodiments, DSPs use token-based protocols or credit-based flow control to ensure that each data stream receives its allocated share of bandwidth without exceeding system capacity.

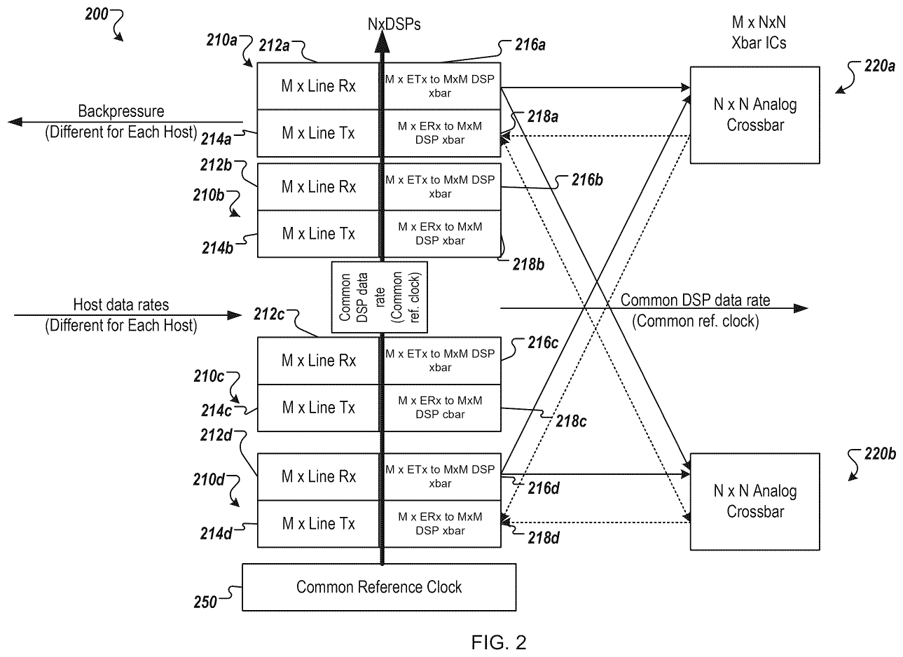

For example, DSPs monitors resource utilization and sends flow control signals to crossbar 340, dynamically adjusting the data transmission rate to prevent bottlenecks. Flow control also ensures equitable distribution of bandwidth among multiple endpoints, optimizing overall system performance. In some embodiments, I/O queue synchronization includes synchronization of input and output queues during crossbar reconfiguration, which ensures seamless traffic flow and prevents data loss. In some embodiments, DSPs and crossbars use time-division multiplexing (TDM) or a common reference clock, as illustrated in FIG. 2, to coordinate queue operations. These synchronization methods align data packet transmission and reception across all components, minimizing latency during dynamic system updates.

In some embodiments, for example, when crossbar 120b in FIG. 1 undergoes reconfiguration, DSPs 110c and 110d temporarily buffer traffic in input queues, ensuring that no data packets are dropped. Output queues synchronize with the reconfigured crossbar to resume normal operation seamlessly.

In some embodiments, backpressure flow control manages traffic flow between DSPs and endpoints, such as servers or storage systems, to prevent data overflows. When an endpoint is congested, it sends a backpressure signal to the upstream DSP, instructing it to pause or throttle data transmission. This prevents buffer overflows and ensures efficient resource utilization.

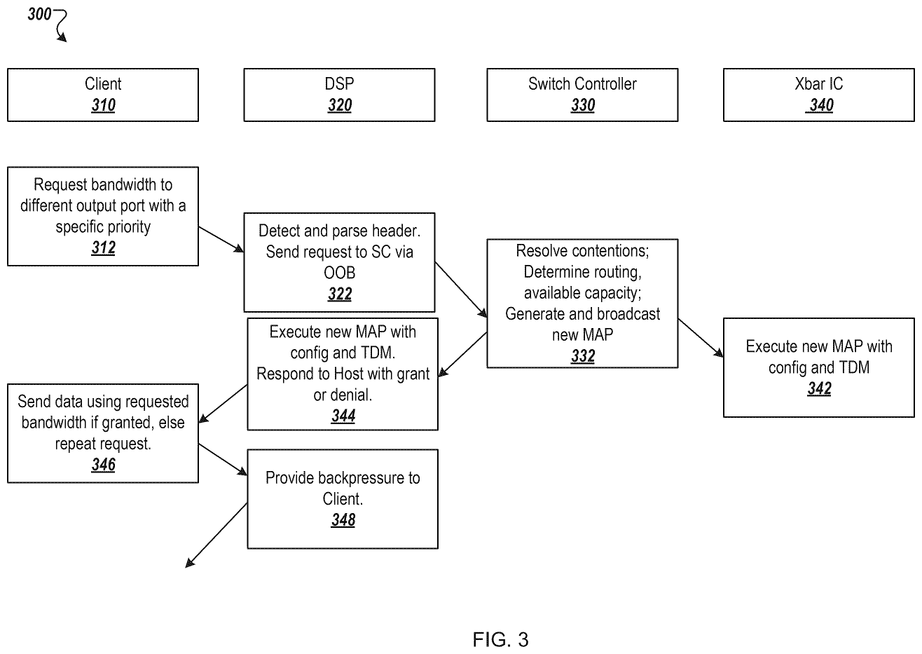

In some embodiments, as illustrated in FIG. 3, DSP 320 receives backpressure signals from client 310 and adjusts its output queue settings accordingly. The switch controller 330 monitors overall system traffic and dynamically adjusts backpressure thresholds based on congestion levels and available resources.

In some embodiments, backpressure signals include metadata indicating the cause of congestion. This information allows DSPs to implement targeted corrective actions, such as rerouting traffic to alternate crossbars or adjusting queue prioritization to alleviate bottlenecks.

Scalability and energy efficiency with respect to queueing and flow control mechanisms are designed to scale with system size and complexity. As the number of DSPs and crossbars increases, the switch controller 130 employs distributed control protocols to manage traffic flow across all components efficiently. These protocols minimize latency and computational overhead, ensuring reliable operation in large-scale deployments.

In some embodiments, energy efficiency is achieved through intelligent queue management and flow control. For example, during periods of low traffic, DSPs reduce queue depth to conserve memory and processing resources, while unused crossbars enter a low-power state. These energy-saving measures are dynamically adjusted based on real-time network demands, ensuring optimal performance with minimal power consumption.

As illustrated in FIG. 2, a device 200 may include a plurality of DSPs 210a, 210b, 210c, 210d that may include various functionality. For example, DSP 210a may include M×Line Rx 212a, M×Line Tx 214a, M×ETx to M×M DSP crossbar 216a, and M×ERx to M×M DSP crossbar 218a. For example, DSP 210b may include M×Line Rx 212b, M×Line Tx 214b, M×ETx to M×M DSP crossbar 216b, and M×ERx to M×M DSP crossbar 218b. For example, DSP 210c may include M×Line Rx 212c, M×Line Tx 214c, M×ETx to M×M DSP crossbar 216c, and M×ERx to M×M DSP crossbar 218c. For example, DSP 210d may include M×Line Rx 212d, M×Line Tx 214d, M×ETx to M×M DSP crossbar 216d, and M×ERx to M×M DSP crossbar 218d. The device may also include a plurality of analog crossbars 220a, 220b. The device may include a common reference clock 250.

DSPs 210a, 210b, 210c, 210d and device 200 may maintain independent data rates (e.g., symbol rates, baud rate, or the like). Instead of transferring a clock from an input (e.g., from the client side) to the output side (e.g., the device side), an independent data rate may be maintained within the device 200 and may be shared across DSPs 210a, 210b, 210c, 210d. Backpressure may be used to adjust the flow of ingress data from the client into DSPs 210a, 210b, 210c, 210d. Within the device 200, DSPs 210a, 210b, 210c, 210d may use identical data rates which may be referenced to a common clock. An equalizer and clock recovery state may be used for various multiplex paths.

DSPs 210a, 210b, 210c, 210d may facilitate flow control. Implementing flow control mechanisms within DSPs 210a, 210b, 210c, 210d and crossbars may facilitate efficient use of shared bandwidth and resources. A DSP may maintain an independent data rate on one or more of its input and/or output lanes. Over or under flow may be avoided through e.g., backpressure mechanisms.

DSPs 210a, 210b, 210c, 210d may facilitate flow control between DSPs 210a, 210b, 210c, 210d and endpoints (e.g., client, server, or the like), using backpressure. Using backpressure techniques to manage traffic flow between DSPs 210a, 210b, 210c, 210d and crossbars may prevent overflows and facilitate efficient resource usage. DSPs 210a, 210b, 210c, 210d may manage independent data rates for input and output lanes, using backpressure techniques to avoid overflows and underflows. Using backpressure may control data flows and avoid congestion.

In a device 200, DSPs 210a, 210b, 210c, 210d may share an independent data rate e.g., reference a common clock signal distributed among DSPs 210a, 210b, 210c, 210d. DSPs 210a, 210b, 210c, 210d may implement queuing specifically for network resource sharing as well as providing backpressure and/or flow control e.g., a layer 2 (L2) function which may allow sharing of a selected output port's bandwidth through TDM. A resource allocation policy may be implemented by allocating buffering and signaling backpressure to requestors in accordance with that policy.

In an example of flow control, port 1, lane 1 and port 2, lane 2 may be in communication with port 8, lane 8. When port 1, lane 1 is communicating with port 8, lane 8, then port 2, lane 2 may be buffering. Once port 2, lane 2 has its turn, port 2, lane 2 may communicate with port 8, lane 8 while port 1, lane 1 is buffering. Buffering may occur at the input and at the output. Buffering at the output provides the advantage that port may be fully utilized at the port. Therefore, there are various ways of buffering including input queueing, output queuing, and virtual output queuing. The memory used for buffering may be distributed across the plurality of DSPs. Because of the distribution of memory, the die size may not increase and scaling limits may not be exceeded.

In FIG. 3, a timing diagram 300 showing communication between a client 310, a DSP 320, a switch controller 330, and a crossbar IC 340 (i.e., including a plurality of analog crossbars) is illustrated. The client 310 may communicate with the DSP 320 by requesting bandwidth to a different output port with a specific priority, as in block 312. The DSP 320 may detect and parse the header and send a request to the switch controller 330 via out-of-band communication, as in block 322. The switch controller 330 may resolve contentions, determine routing and available capacity, and generate and broadcast new MAP, as in block 332. The crossbar IC 340 may execute the new MAP with configuration and TDM, as in block 342. The DSP 320 may execute new MAP with configuration and TDM, and respond to the host with grant or denial, as in block 344. The client 310 may send data using requested bandwidth if granted, or else repeat the request, as in block 346. The DSP 320 may provide backpressure to the client 310, as in block 348.

In addition or alternatively, the AECS may be an optical circuit switch (OCS). Thus, any technique suitable described herein for an AECS may be applied to an OCS.

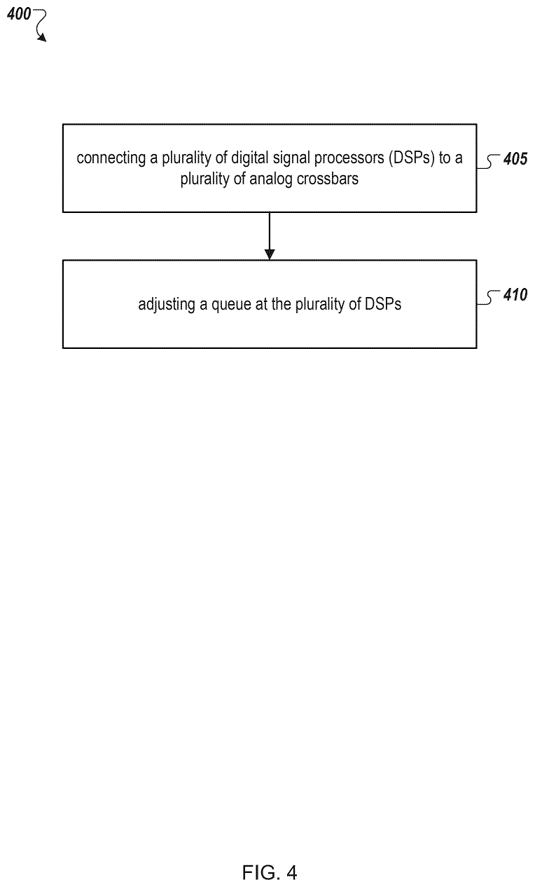

FIG. 4 illustrates a process flow of an example method 400 for queueing, in accordance with at least one example described in the present disclosure. The method 400 may be arranged in accordance with at least one example described in the present disclosure.

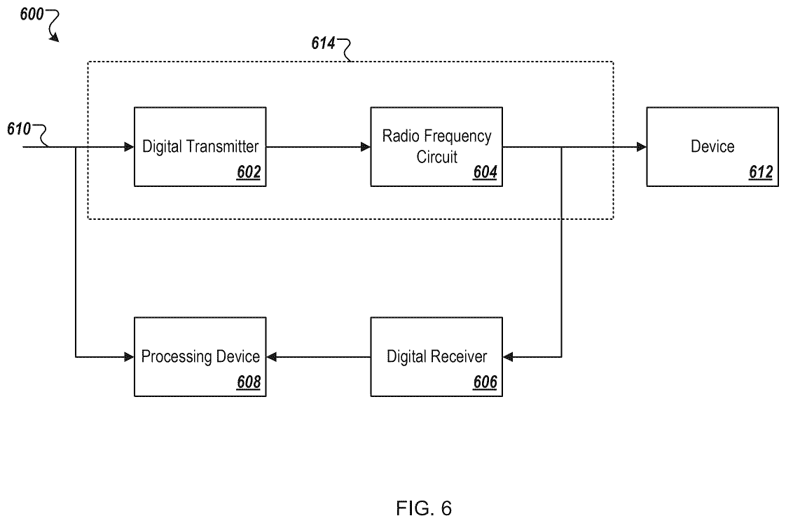

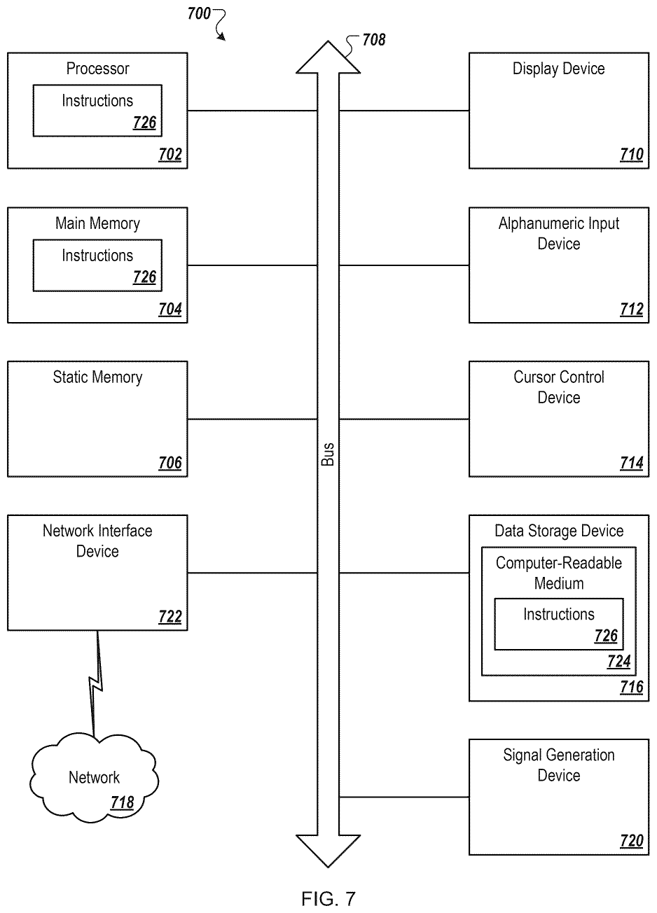

The method 400 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems.

The method 400 may begin at block 405 where the processing logic may connect DSPs to analog crossbars.

At block 410, the processing logic may adjust a queue at the plurality of DSPs.

The processing logic may adjust one or more of a queue depth or a queue prioritization. The processing logic may adjust the queue in response to one or more of a traffic usage, a latency target, or a resource availability. The queue may be one or more of an input queue, an output queue, a virtual output queue, or a hybrid queue. The processing logic may facilitate flow control at the plurality of DSPs. The processing logic may facilitate flow control between the plurality of DSPs and endpoints using backpressure. The processing logic may synchronize the queue in which the queue may be one or more of an input queue or an output queue. The processing logic may synchronize the queue during crossbar reconfiguration. The processing logic may facilitate network resource sharing by adjusting the queue.

Modifications, additions, or omissions may be made to the method 400 without departing from the scope of the present disclosure. For example, in some examples, the method 400 may include any number of other components that may not be explicitly illustrated or described.

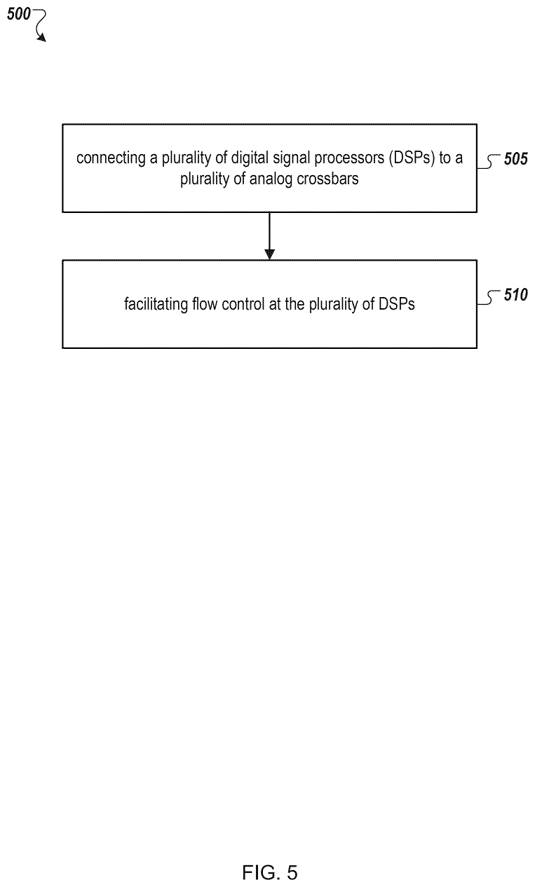

FIG. 5 illustrates a process flow of an example method 500 for flow control, in accordance with at least one example described in the present disclosure. The method 500 may be arranged in accordance with at least one example described in the present disclosure.

The method 500 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems.

The method 500 may begin at block 505 where the processing logic may connect DSPs to analog crossbars.

At block 510, the processing logic may facilitate flow control at the plurality of DSPs

The processing logic may facilitate the flow control by adjusting backpressure.

Modifications, additions, or omissions may be made to the method 500 without departing from the scope of the present disclosure. For example, in some examples, the method 500 may include any number of other components that may not be explicitly illustrated or described.

Referring now to FIGS. 1-5 in conjunction, in some embodiments, the AECS switch 100 utilizes adaptive scheduling algorithms, such as weighted round-robin (WRR), deficit weighted round-robin (DWRR), or priority-based scheduling, to dynamically manage queue depth and ensure efficient traffic flow. As illustrated in FIG. 1, DSPs 110a-110d implement these scheduling techniques to prioritize traffic streams based on latency, bandwidth demands, or application-level quality of service (QoS) metrics. For instance, WRR scheduling enables proportional allocation of bandwidth across queues while minimizing starvation of lower-priority traffic. Similarly, DWRR allows for fair resource allocation by accounting for packet size variations, further enhancing throughput in heterogeneous traffic conditions.

In some embodiments, to prevent overflows while maintaining high throughput, DSPs 110a-110d dynamically adjust backpressure thresholds based on real-time traffic conditions and resource availability. As shown in FIG. 2, backpressure signals propagate from downstream components, such as crossbars 220a-220b, to upstream DSPs 210a-210d, instructing them to pause or throttle data transmission when congestion is detected. These thresholds are not static; they are recalibrated dynamically in response to metrics such as queue depth, link utilization, and latency measurements. For example, during periods of high congestion, lower thresholds may be set to quickly relieve bottlenecks, while during low traffic, thresholds may be raised to maximize throughput.

In some embodiments, the DSPs dynamically merge or partition queues to adapt to fluctuating traffic demands. As illustrated in FIG. 3, when multiple low-priority queues experience underutilization, they may be merged into a single virtual queue to optimize memory usage and streamline scheduling. Conversely, during high traffic periods, a single overloaded queue may be partitioned into multiple smaller queues, each serving a specific traffic flow or destination. This approach is particularly advantageous for handling bursty traffic patterns, as it reduces packet drop rates and ensures even distribution of resources across active traffic streams.

As shown in FIG. 4, DSPs 320 implement virtual queueing mechanisms that allow logical separation of traffic flows without requiring dedicated physical queues for each stream. Virtual output queues (VOQs), for example, enable the DSPs to maintain separate logical queues for each potential crossbar output port, as illustrated by crossbars 340 in FIG. 3. This reduces head-of-line blocking and improves overall system throughput. In some embodiments, hybrid queueing is implemented by combining input queues, output queues, and VOQs. This hybrid approach optimizes memory usage while maintaining high levels of flexibility and performance.

In some embodiments, the queueing mechanisms incorporate multiple-input multiple-output (MIMO) and first-in-first-out (FIFO) strategies. MIMO-based queuing allows for parallel processing of multiple data streams, as illustrated in FIG. 2, where DSPs 210a-210d simultaneously handle multiple ingress and egress lanes. FIFO queues, on the other hand, ensure sequential processing of traffic, making them ideal for latency-sensitive applications. By combining these strategies, the AECS switch 100 dynamically selects the most suitable queueing mechanism based on traffic characteristics and application.

As illustrated in FIG. 5, the processing logic dynamically expands queue depth during traffic bursts to accommodate higher data volumes without packet loss. For instance, when a sudden influx of high-priority packets is detected, DSPs 210a-210d temporarily allocate additional memory to affected queues. Once the traffic normalizes, the queue depth is reduced to conserve resources. Additionally, predictive algorithms may identify patterns of recurring bursts, allowing DSPs to preemptively adjust queue settings and prevent congestion.

The above describe queue management strategies ensure that the AECS switch 100 achieves high throughput, low latency, and efficient resource utilization, even in the most demanding network environments. By dynamically adapting to traffic conditions, the system minimizes congestion and maintains reliable performance across diverse application scenarios.

In some embodiments, the AECS switch 100 implements granular backpressure signaling to manage congestion more precisely. As shown in FIG. 1, DSPs 110a-110d receive backpressure signals from endpoints, such as servers or storage systems, when congestion occurs. Rather than halting all traffic flows, the DSPs selectively throttle only the affected data streams, maintaining throughput for unaffected flows. For example, if crossbar 120a experiences partial congestion on one output port, DSPs 110a-110d reduce the data rate for that specific port while maintaining normal operation for other ports. This targeted approach prevents unnecessary disruptions and maximizes overall system performance.

As illustrated in FIG. 3, backpressure metadata transmitted by client 310 or crossbar 340 may include detailed information about the nature of congestion, such as the affected queues or traffic types. DSP 320 uses this information to implement priority-aware flow control, ensuring that high-priority traffic streams, such as real-time video or mission data, are given precedence over lower-priority traffic. This method ensures that traffic is transmitted with minimal delay, even during periods of congestion, while low-priority flows are slowed down or buffered.

In some embodiments, for example when multiple crossbars, such as 220a and 220b in FIG. 2, are connected within the AECS switch 100, inter-crossbar flow control mechanisms ensure seamless data transmission. For instance, when crossbar 220a becomes congested, it sends backpressure signals to crossbar 220b, which then relays these signals to the upstream DSPs. This cascade of signals ensures that congestion is managed holistically across the entire system. In some embodiments, the switch controller 130 dynamically adjusts routing and load balancing across crossbars to mitigate bottlenecks, redirecting traffic from congested paths to alternate, less utilized paths.

In some embodiments, DSPs 110a-110d implement predictive flow control mechanisms based on historical traffic patterns and real-time monitoring. As illustrated in FIG. 4, the processing logic analyzes traffic metrics such as average data rates, peak congestion times, and latency trends to anticipate potential bottlenecks. For example, if a recurring traffic surge is identified during specific intervals, the system preemptively increases buffer allocation and adjusts flow control parameters for the affected paths. This proactive approach reduces the likelihood of congestion and improves overall system stability.

As illustrated in FIG. 5, crossbars 120a-120c dynamically adjust their flow control settings to optimize data transmission. For example, if crossbar 120a detects a high volume of incoming data from DSP 210a, it temporarily increases its buffer capacity and notifies the upstream DSP to slow down transmission via backpressure signals. Once the congestion subsides, the crossbar resumes normal operation, freeing up resources for other traffic flows. This dynamic adjustment prevents packet loss and ensures efficient utilization of crossbar resources.

Flow control mechanisms in the AECS switch 100 operate across multiple layers, ensuring end-to-end congestion management. As shown in FIG. 2, backpressure signals from endpoints propagate through DSPs, crossbars, and the switch controller. This hierarchical approach allows for granular adjustments at each layer, from individual queues in DSPs to global traffic policies enforced by the switch controller. For instance, the switch controller 130 may impose global rate limits on specific traffic classes during peak usage periods while DSPs and crossbars handle localized congestion.

In some embodiments, the switch controller 130 reroutes traffic dynamically to alleviate congestion. For example, if crossbar 120b is experiencing high traffic loads, the switch controller redirects incoming data to alternate crossbar 120c. DSPs 110c and 110d buffer the rerouted traffic temporarily, ensuring no data loss during the transition. This capability, combined with granular backpressure signaling, provides a robust mechanism for managing congestion across the AECS switch 100.

Such flow control ensure that the AECS switch 100 maintains high efficiency and reliability, even in complex and variable network environments. By combining granular signaling, predictive mechanisms, and dynamic adjustments, the system achieves optimal traffic management and resource utilization.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 6 illustrates a block diagram of an example communication system 600 configured for queueing and flow control, in accordance with at least one example described in the present disclosure. The communication system 600 may include a digital transmitter 602, a radio frequency circuit 604, a device 612, a digital receiver 606, and a processing device 608. The digital transmitter 602 and the processing device may be configured to receive a baseband signal via connection 610. A transceiver 614 may comprise the digital transmitter 602 and the radio frequency circuit 604.

In some examples, the communication system 600 may include a system of devices that may be configured to communicate with one another via a wired or wireline connection. For example, a wired connection in the communication system 600 may include one or more Ethernet cables, one or more fiber-optic cables, and/or other similar wired communication mediums. Alternatively, or additionally, the communication system 600 may include a system of devices that may be configured to communicate via one or more wireless connections. For example, the communication system 600 may include one or more devices configured to transmit and/or receive radio waves, microwaves, ultrasonic waves, optical waves, electromagnetic induction, and/or similar wireless communications. Alternatively, or additionally, the communication system 600 may include combinations of wireless and/or wired connections. In these and other examples, the communication system 600 may include one or more devices that may be configured to obtain a baseband signal, perform one or more operations to the baseband signal to generate a modified baseband signal, and transmit the modified baseband signal, such as to one or more loads.

In some examples, the communication system 600 may include one or more communication channels that may communicatively couple systems and/or devices included in the communication system 600. For example, the transceiver 614 may be communicatively coupled to the device 612.

In some examples, the transceiver 614 may be configured to obtain a baseband signal. For example, as described herein, the transceiver 614 may be configured to generate a baseband signal and/or receive a baseband signal from another device. In some examples, the transceiver 614 may be configured to transmit the baseband signal. For example, upon obtaining the baseband signal, the transceiver 614 may be configured to transmit the baseband signal to a separate device, such as the device 612. Alternatively, or additionally, the transceiver 614 may be configured to modify, condition, and/or transform the baseband signal in advance of transmitting the baseband signal. For example, the transceiver 614 may include a quadrature up-converter and/or a digital to analog converter (DAC) that may be configured to modify the baseband signal. Alternatively, or additionally, the transceiver 614 may include a direct radio frequency (RF) sampling converter that may be configured to modify the baseband signal.

In some examples, the digital transmitter 602 may be configured to obtain a baseband signal via connection 610. In some examples, the digital transmitter 602 may be configured to up-convert the baseband signal. For example, the digital transmitter 602 may include a quadrature up-converter to apply to the baseband signal. In some examples, the digital transmitter 602 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 602.

In some examples, the transceiver 614 may include one or more subcomponents that may be used in preparing the baseband signal and/or transmitting the baseband signal. For example, the transceiver 614 may include an RF front end (e.g., in a wireless environment) which may include a power amplifier (PA), a digital transmitter (e.g., 602), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 604) of the transceiver 614 may be synchronized with the resource controller via the S-plane device, which may contribute to high-accuracy timing with respect to a reference clock.

In some examples, the transceiver 614 may be configured to obtain the baseband signal for transmission. For example, the transceiver 614 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 614 may be configured to generate a baseband signal for transmission. In these and other examples, the transceiver 614 may be configured to transmit the baseband signal to another device, such as the device 612.

In some examples, the device 612 may be configured to receive a transmission from the transceiver 614. For example, the transceiver 614 may be configured to transmit a baseband signal to the device 612.

In some examples, the radio frequency circuit 604 may be configured to transmit the digital signal received from the digital transmitter 602. In some examples, the radio frequency circuit 604 may be configured to transmit the digital signal to the device 612 and/or the digital receiver 606. In some examples, the digital receiver 606 may be configured to receive a digital signal from the RF circuit and/or send a digital signal to the processing device 608.

In some examples, the processing device 608 may be a standalone device or system, as illustrated. Alternatively, or additionally, the processing device 608 may be a component of another device and/or system. For example, in some examples, the processing device 608 may be included in the transceiver 614. In instances in which the processing device 608 is a standalone device or system, the processing device 608 may be configured to communicate with additional devices and/or systems remote from the processing device 608, such as the transceiver 614 and/or the device 612. For example, the processing device 608 may be configured to send and/or receive transmissions from the transceiver 614 and/or the device 612. In some examples, the processing device 608 may be combined with other elements of the communication system 600.

FIG. 7 illustrates a diagrammatic representation of a machine in the example form of a computing device 700 within which a set of instructions, for causing the machine to perform any one or more of the methods discussed herein, may be executed. The computing device 700 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a DSP, network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one example, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

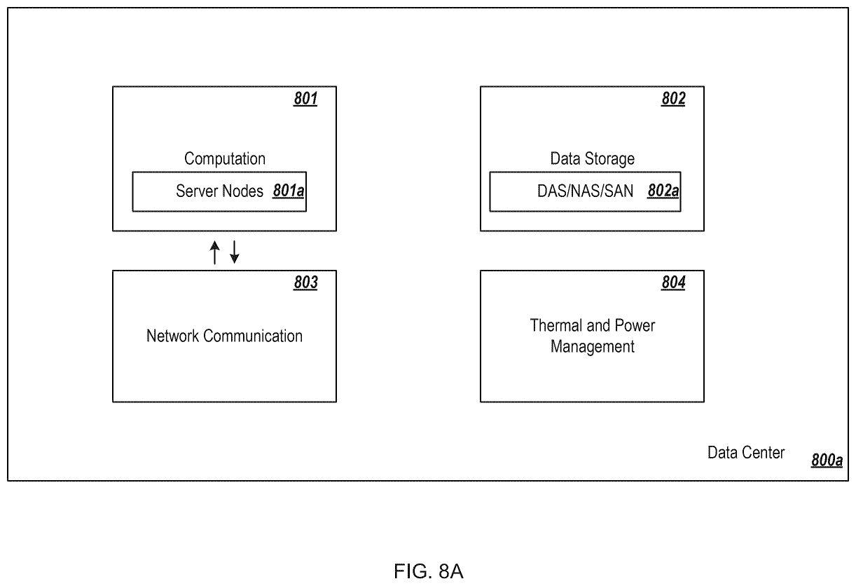

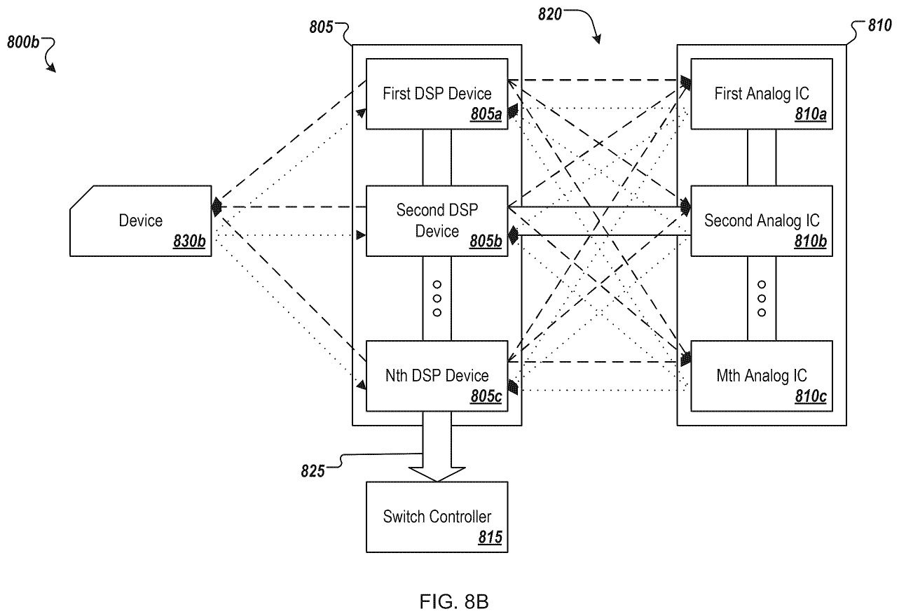

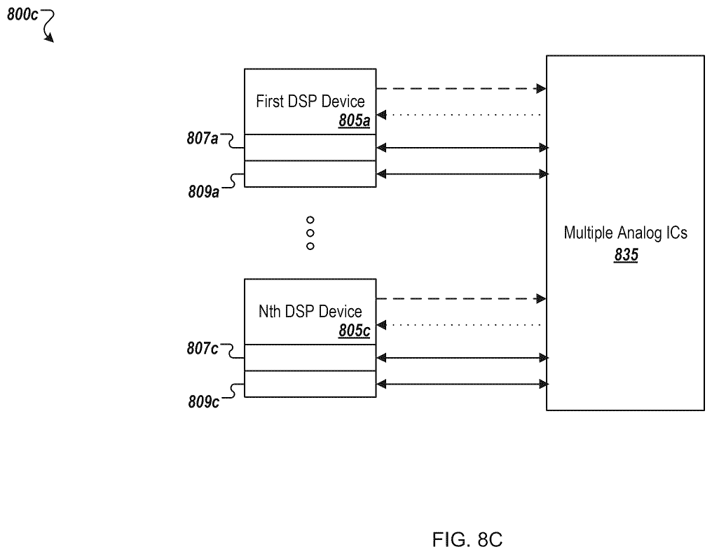

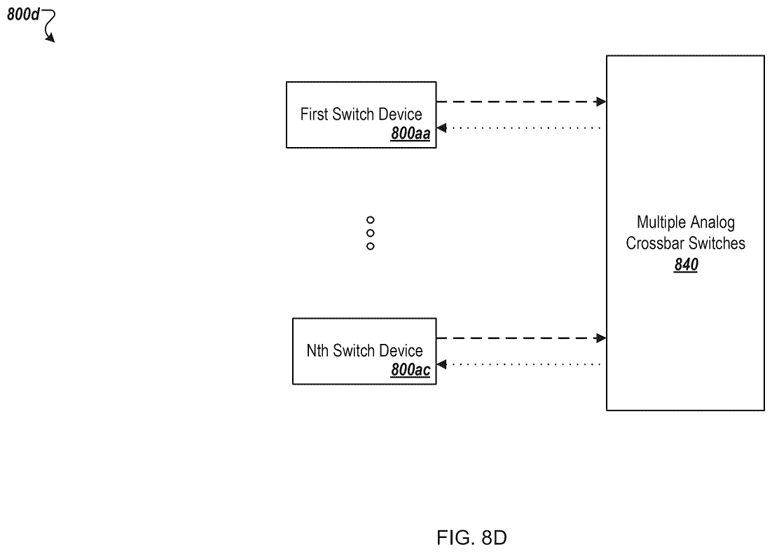

As illustrated in FIG. 8A, a block diagram of a data center 800a may include multiple subsystems configured to perform various operational functions, including computation 801, data storage 802, network communication 803, and thermal and power management 804. The computation 801 subsystem may include one or more server nodes 801a that may execute software applications and process data workloads. The data storage 802 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 802a. The networking communication 803 subsystem may facilitate bidirectional data transfer between servers and external networks through high-speed switching and routing components. The thermal and power management 804 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 800a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch system on chips (SOCs) with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 8B illustrates an example switch device 800b. The switch device 800b may include a first digital signal processor (DSP) device 805a, a second DSP device 805b, an nth DSP device 805c, referred to collectively as multiple first electronic devices 805, a first analog integrated circuit (IC) 810a, a second analog IC 810b, an mth analog IC 810c, referred to collectively as multiple second electronic devices 810, a switch controller 815, in-band traffic 820, and out-of-band traffic 825. First DSP 805a, second DSP 805b, and nth DSP 805c may have input and output.

The switch device 800b may be reconfigurable (e.g., in terms of the connections between the components therein, such as the multiple first electronic devices 805 and the multiple second electronic devices 810, the switch controller 815, and/or a device 830), where the switching of the connections/lanes between the components may be low latency (e.g., less than 5 ns, 10 ns, or the like switching). Alternatively, or additionally, the switch device 800b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 805 may individually include one or more ports that may be used to facilitate communications within the switch device 800b, such as between the multiple first electronic devices 805 and the multiple second electronic devices 810, the switch controller 815, and/or a device 830. The communications in the switch device 800b may be transmitted via multiple lanes in the switch device 800b. The multiple lanes may facilitate the in-band traffic 820 and/or the out-of-band traffic 825.

The multiple lanes between the multiple first electronic devices 805 and the multiple second electronic devices 810 may be in an any-to-any configuration. For example, the first DSP device 805a may include a lane to the first analog IC 810a, to the second analog IC 810b, and/or the mth analog IC 810c. A similar arrangement may occur for each of the multiple first electronic devices 805, such that each DSP device of the multiple first electronic devices 805 may include a lane to any number of the multiple second electronic devices 810, including none of the multiple second electronic devices 810. Each lane for facilitating the in-band traffic 820 may be in both directions (e.g., transmit and receive) between the multiple first electronic devices 805, the multiple second electronic devices 810, and/or a device 830. Alternatively, or additionally, the lanes are dashed/dotted to illustrate that for any transmit/receive path between the multiple first electronic devices 805, the multiple second electronic devices 810, and/or a device 830, a lane may or may not be present.

The multiple first electronic devices 805, the multiple second electronic devices 810, and/or the switch controller 815 may be disposed on a printed circuit board (PCB) where traces on the PCB may be used to connect at least the multiple first electronic devices 805, the multiple second electronic devices 810, and/or the switch controller 815 (e.g., the traces on the PCB may facilitate the in-band traffic 820 and/or the out-of-band traffic 825 in the switch device 800b). Alternatively, or additionally, the multiple first electronic devices 805, the multiple second electronic devices 810, and/or the switch controller 815 may be connected to one another using connectors, such as high-speed cables, where the multiple first electronic devices 805, the multiple second electronic devices 810, and/or the switch controller 815 may individually include ports/headers to support the use of the connectors. In instances in which the connectors are used, crosstalk between the multiple lanes in the switch device 800b may be reduced relative to the crosstalk that may occur when the switch device 800b uses traces on a PCB.

The switch device 800b, including the multiple first electronic devices 805, the multiple second electronic devices 810, and/or the switch controller 815, may be utilized with one or more additional switches and/or crossbar devices to form a new crossbar switch device, which may be larger than any one of the switch devices 800b. For example, as illustrated and discussed relative to FIG. 8C, the switch device 800b may be utilized with any other number of switch devices 800b (e.g., the nth switch device 800ac in FIG. 8C) and multiple analog crossbar switches 840 to form a new crossbar switch device.

The multiple first electronic devices 805 may be digital signal processors (DSPs) and/or the multiple second electronic devices 810 may be analog circuit switch integrated circuits (ICs) for use with electrical signals. Alternatively, or additionally the multiple second electronic devices 810 may be analog optical circuit switch ICs for use with optical signals. The multiple first electronic devices 805 may be individually configured to support one or more layer of the open systems interconnection (OSI) model. For example, each of the multiple first electronic devices 805 may be configured to support layer 1 protocols, layer 2 protocols, and/or layer 3 protocols with respect to the in-band traffic 820 and/or the out-of-band traffic 825.

Each, or at least one, of the multiple first electronic devices 805 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 805 may be able to adjust the way in which traffic is directed through it, such as in response to a command from the switch controller 815. For example, each of the multiple first electronic devices 805 may be operable to configure an internal switch, an external switch, or a crossbar based on the various layer protocol processing to be performed.

The first DSP device 805a may receive a communication that includes a frame header (or a packet header) and the first DSP device 805a may be configured to detect the frame header and decode the frame header along with any associated contents of the communication, all within the first DSP device 805a. In a second example, the first DSP device 805a may integrate a media access control (MAC) address lookup table which may allow the first DSP device 805a to configure one or more crossbars such that the first DSP device 805a may facilitate connectivity between any two MAC addresses that are included in the lookup table. Alternatively, or additionally, each of the first electronic devices 805 may include a lookup table that may store equalization settings that may be used for various connections between the first electronic devices 805 and other components within the switch device 800b. The equalization settings in the lookup table may be used to accelerate acquisition and/or tracking for a particular DSP device of the multiple first electronic devices 805 when the particular DSP device switches connections within the switch device 800b.

The multiple first electronic devices 805 may be configured to respond to layer 2 protocol requests and/or layer 3 protocol requests for connectivity and/or resource grant requests. For example, the multiple first electronic devices 805 may compare a request to a lookup table that includes priority levels and the multiple first electronic devices 805 may be operable to configure themselves and/or associated crossbars and/or switches based on the determined priority level. Alternatively, or additionally, each of the multiple first electronic devices 805 may be configured to respond to in-band requests (e.g., granting a connection request, signaling backpressure to the device 830, etc.), collect statistics on traffic handled by the multiple first electronic devices 805 (e.g., link utilization and/or traffic type), and/or perform data filtering (e.g., detecting a particular header, performing routing, generating flags and/or interrupts, and/or logging any of the filtering events).

The multiple first electronic devices 805 may be configured to communicate with (e.g., transmit data to and/or receive data from) the device 830. The communication with the device 830 may include in-band traffic 820. In such instances, the communications between the multiple first electronic devices 805 and the device 830 may be line-side communications, where the lines may facilitate communications using various communication channels. For example, the line-side communications between the multiple first electronic devices 805 and the device 830 may be an electrical-to-electrical connection, an optical-to-optical connection, an electrical-to-optical connection, or an optical-to-electrical connection, and so forth.

The device 830 may address communications directly to one of the multiple first electronic devices 805. For example, the device 830 may address communications to the second DSP device 805b. Alternatively, or additionally, the device 830 may address communications to the switch controller 815, which may then direct communications to the appropriate DSP device. For example, the device 830 may address communications intended for the second DSP device 805b to the switch controller 815 and the switch controller 815 may direct the communications to the second DSP device 805b.

The multiple first electronic devices 805 may individually include memory that may be used as a buffer for communications through the multiple first electronic devices 805. The memory in the multiple first electronic devices 805 may be utilized to buffer incoming and/or outgoing traffic, which may include in-band traffic 820 and/or out-of-band traffic 825. Due to the memory in the multiple first electronic devices 805 being distributed (e.g., by the distributed nature of the multiple first electronic devices 805), the switch device 800b may not include any memory for buffering in addition to the memory included in the multiple first electronic devices 805.

The multiple first electronic devices 805 may individually include one or more additional lanes that may be used for communications in the switch device 800b. Further details associated with the additional lanes are included in the description associated with FIG. 8C.

The multiple second electronic devices 810 may individually include one or more ports that may be used to facilitate communications within the switch device 800b, similar to the ports described relative to the multiple first electronic devices 805. Alternatively, or additionally, the lanes for communications between the multiple first electronic devices 805 and the multiple second electronic devices 810 may be coupled with the ports included in the multiple second electronic devices 810.

The switch controller 815 may be a microcontroller unit (MCU). Alternatively, or additionally, the switch controller 815 may be a DSP, or other processing device. The switch controller 815 may be communicatively coupled with at least the multiple first electronic devices 805 and/or the multiple second electronic devices 810. The switch controller 815 may resolve resource grant requests, distribute the network state to the multiple first electronic devices 805 and/or to the multiple second electronic device 810, and/or may establish and/or maintain timing among the components included in the switch device 800b.

The switch controller 815 may communicate with the multiple first electronic devices 805 and/or the multiple second electronic devices 810 using a separate connection/lane than the connections between the multiple first electronic devices 805 and the multiple second electronic devices 810. For example, the first connection between the multiple first electronic devices 805 and the multiple second electronic devices 810 may facilitate the in-band traffic 820 and the second connection between the switch controller 815 and the multiple first electronic devices 805 and/or the multiple second electronic devices 810 may facilitate the out-of-band traffic 825.

The out-of-band traffic 825 may use a different network than the in-band traffic 820. Alternatively, or additionally, the out-of-band traffic 825 may use a different physical layer protocol than the in-band traffic 820. The out-of-band traffic 825 may be used to manage and/or configure one or more components included in the switch device 800b. For example, the switch controller 815 may communicate with the multiple first electronic devices 805 using the out-of-band traffic 825 to reconfigure lanes and/or traffic routing based on the traffic through the switch device 800b.

The switch controller 815 may be programmable such that the switch controller 815 may be operable to dynamically map the lanes between the multiple first electronic devices 805 and the multiple second electronic devices 810. For example, in instances in which the first DSP device 805a includes a lane to the first analog IC 810a, the switch controller 815 may dynamically map the lane to be from the first DSP device 805a to the second analog IC 810b. The switch controller 815 may dynamically adapt the mapping of the lanes between the multiple first electronic devices 805 and the multiple second electronic devices 810 based on one or more conditions and/or a satisfaction of a threshold related to the conditions. For example, in instances in which the real-time data traffic in the switch device 800b (or an amount of real-time data traffic handled by one of the multiple first electronic devices 805 and/or one of the multiple second electronic devices 810) satisfies a threshold, the switch controller 815 may dynamically adapt the mapping of the lanes as described.

The switch device 800b may include one or more redundant lanes that may be used in various situations during operation of the switch device 800b. For example, one or more redundant lanes may be used for the out-of-band traffic 825, such as signaling using the out-of-band traffic 825. In such instances, the out-of-band signaling may be transmitted and/or received by a particular DSP device and/or by the switch controller 815, and the out-of-band signaling may be a lower transmission rate than the in-band traffic 820. In another example, one or more redundant lanes may be used for out-of-bandwidth broadcasts from the switch controller 815 and/or from one or more of the multiple first electronic devices 805 to other devices in the switch device 800b (e.g., such as other DSP devices).

The switch controller 815 may reserve a portion of bandwidth associated with the in-band traffic 820 in the switch device 800b. The bandwidth reserved by the switch controller 815 may be reserved on a per lane basis of the multiple lanes included in the switch device 800b. For example, a first lane between the first DSP device 805a and the first analog IC 810a may have a first reserved bandwidth and a second lane between the second DSP device 805b and the second analog IC 810b may have a second reserved bandwidth, where the amount of bandwidth reserved may be the same or may differ between the first reserved bandwidth and the second reserved bandwidth. The switch controller 815 may allocate resources within the switch device 800b based on predicted or anticipated traffic (e.g., based on a probabilistic model).

Alternatively, or additionally, the switch controller 815 may monitor the lanes of the multiple lanes in the switch device 800b. The switch controller 815 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 815 may dynamically remap a new lane in the switch device 800b to replace the degraded lane.

The switch controller 815 may perform adaptive signal equalization to the in-band traffic 820 in the switch device 800b. For example, the multiple first electronic devices 805 may provide feedback to the switch controller 815 relative to the workload handled by the multiple first electronic devices 805, and the switch controller 815 may adaptively manage workloads of the multiple first electronic devices 805 to optimize performance of the switch device 800b.

A backup switch controller (not illustrated) may be included in the switch device 800b. The backup switch controller may be a redundant controller relative to the switch controller 815. The backup switch controller may include the same or similar connections as the switch controller 815 relative to the multiple first electronic devices 805 and/or the multiple second electronic devices 810. The backup switch controller may perform the same or similar operations as the switch controller 815.

FIG. 8C illustrates an example switch device 800c. The switch device 800c may include a first DSP device 805a, an nth DSP device 805c, and multiple analog ICs 835. The first DSP device 805a may include a first auxiliary channel 807a, and a first out-of-band channel 809a. The nth DSP device 805c may include an nth auxiliary channel 807c, and an nth out-of-band channel 809c.

The first DSP device 805a, the nth DSP device 805c, and the multiple analog ICs 835 may be the same or similar as the first DSP device 805a, the nth DSP device 805c, and the multiple second electronic devices 810, respectively, of FIG. 8A and may be operable to perform the same or similar functions as described.

The auxiliary channels 807 (e.g., the first auxiliary channel 807a and the second auxiliary channel 807c) may be individually utilized by each of the DSP devices 805a, 805c as an additional lane for in-band traffic between at least the DSP devices 805a, 805c and the multiple analog ICs 835. The auxiliary channels 807 may be used to redundantly transmit in-band traffic relative to another lane included in the DSP devices 805a, 805c prior to a change in configuration to the corresponding DSP devices 805a, 805c. For example, in instances in which the first DSP device 805a includes a lane to a particular analog IC of the multiple analog ICs 835 and the first DSP device 805a is to be reconfigured (e.g., by a switch controller as described herein), the first auxiliary channel 807a may have a lane mapped to the particular analog IC such that the in-band traffic is redundant between the first DSP device 805a and the particular analog IC prior to reconfiguring the lanes associated with the first DSP device 805a (which reconfiguration may otherwise break the connection between the first DSP device 805a and the particular analog IC).

The auxiliary channels 807 may be used for communication between other near DSP devices. For example, in instances in which the first DSP device 805a is disposed spatially near to the nth DSP device 805c, the first DSP device 805a and the nth DSP device 805c may communicate with one another via the auxiliary channels 807. Such communications may be possible as the channels between near-neighbors may be relatively clean, such that physical layer processing may be simplified and may result in power reduction, latency reduction, a lesser amount of equalization, and/or other benefits to the switch device 800c.

The out-of-band channels 809 may be used to communicate the out-of-band traffic (e.g., the out-of-band traffic 825 of FIG. 8B) on a lane separate from the multiple lanes used to communicate in-band traffic. In such instances, the out-of-band channels 809 may not cause blocking or interference to the in-band traffic between at least the DSP devices 805a, 805c and the multiple analog ICs 835.

FIG. 8D illustrates an example aggregated switch device 800d. The aggregated switch device 800d may include a first switch device 800aa, an nth switch device 800ac, and multiple analog crossbar switches 840. The first switch device 800aa and the nth switch device 800ac may individually be the same or similar as the switch device 800b of FIG. 8B.

The aggregated switch device 800d illustrates that any number of the switch devices 800b (e.g., the first switch device 800aa and the nth switch device 800ac) may be aggregated into another switch device and/or connected to other analog crossbar switches. Each of the switch devices 800b may include multiple DSP devices and multiple analog IC and may be further aggregated into the aggregated switch device 800d using the multiple analog crossbar switches 840. As such, the aggregated switch device 800d may be scaled up or down for any size communication need, by adjusting the switch devices 800b and/or the multiple analog crossbar switches 840 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs); and
a plurality of analog crossbars in communication with the plurality of DSPs,
wherein the plurality of DSPs are operable to adjust a queue at the plurality of DSPs based on real-time traffic conditions.

2. The device of claim 1, wherein the queue is adjusted by modifying one or more of a queue depth, a queue prioritization level, or a queue allocation.

3. The device of claim 1, wherein the queue is adjusted in response to one or more of a traffic usage, a latency target, a congestion state, or a resource availability.

4. The device of claim 1, wherein the queue is one or more of an input queue, an output queue, a virtual output queue, a hybrid queue, or a partitioned queue.

5. The device of claim 1, wherein the plurality of DSPs are operable to facilitate flow control through token-based protocols or credit-based mechanisms.

6. The device of claim 1, wherein the plurality of DSPs are operable to facilitate flow control between the plurality of DSPs and endpoints using backpressure signaling.

7. The device of claim 1, wherein the plurality of DSPs are operable to adjust flow control parameters in response to partial congestion signals, selectively slowing down affected data streams while maintaining unaffected traffic flows.

8. The device of claim 1, wherein the plurality of DSPs are operable to synchronize one or more of input queues or output queues during crossbar reconfiguration to minimize latency and prevent data loss.

9. The device of claim 1, wherein the plurality of DSPs are operable to dynamically merge or partition queues based on traffic demand, latency, or resource utilization.

10. The device of claim 1, wherein the plurality of DSPs are operable to implement priority-based scheduling algorithms, including weighted round-robin (WRR) or deficit weighted round-robin (DWRR), to optimize traffic flow across crossbars.

11. A method, comprising:
connecting a plurality of digital signal processors (DSPs) to a plurality of analog crossbars; and
adjusting a queue at the plurality of DSPs based on one or more traffic metrics.

12. The method of claim 11, further comprising adjusting one or more of a queue depth, a queue prioritization level, or a queue allocation in response to real-time traffic conditions.

13. The method of claim 11, further comprising dynamically adjusting the queue in response to one or more of traffic usage, latency targets, congestion states, or resource availability.

14. The method of claim 11, wherein the queue is one or more of an input queue, an output queue, a virtual output queue, a hybrid queue, or a partitioned queue.

15. The method of claim 11, further comprising facilitating flow control at the plurality of DSPs using token-based or credit-based mechanisms to allocate bandwidth efficiently.

16. The method of claim 11, further comprising facilitating flow control between the plurality of DSPs and endpoints using granular backpressure signaling to selectively adjust data flows.

17. The method of claim 11, further comprising synchronizing one or more of input queues or output queues during crossbar reconfiguration to prevent traffic delays or data loss.

18. The method of claim 11, further comprising dynamically merging or partitioning queues at the plurality of DSPs to address fluctuating traffic demands.

19. The method of claim 11, further comprising implementing adaptive scheduling algorithms, including weighted round-robin (WRR) or deficit weighted round-robin (DWRR), to manage traffic prioritization.

20. A method, comprising:
connecting a plurality of digital signal processors (DSPs) to a plurality of analog crossbars; and
facilitating flow control at the plurality of DSPs through backpressure signaling.
